(19) United States
(12) Patent Application Publication
(10) Pub. No.: US 2007/0206761 A1
(43) Pub. Date: Sep. 6, 2007

(54) Comparative tone return time three-way call detect

(76) Inventors: Joseph Clifford Anders, Mobile, AL (US); Jeremy Lee Birch, Mobile, AL (US); Kenneth Allen Salter JR., Mobile, AL (US); Xiaojiang Song, Mobile, AL (US)

Correspondence Address: DORITY & MANNING, P.A., POST OFFICE BOX 1449, GREENVILLE, SC, 29602-1449, US

(21) Appl. No.: 11/247,952

(22) Filed: Oct. 11, 2005

Related U.S. Application Data
(60) Provisional application No. 60/617,944, filed on Oct. 12, 2004.

(51) Int. Cl. H04M 3/42

(52) U.S. Cl. 379/207.01

(57) ABSTRACT

The present subject matter is directed to an apparatus and methodology for detecting three-way call attempts during telephone conversations. Per the methodology, apparatus is configured to, in effect, “ping” a called telephone by transmitting an audio frequency range tone over the loop established from the calling telephone to the called telephone, measuring the tone return time and using that measurement as a base measurement comparison point for additional measurements during the course of a conversation. The base measurement would be inherently determined by the particular path established for a given call, which path does not ordinarily change during the call. If the return time for a subsequent measurement deviates significantly from the base measurement, a determination is made that a three-way call attempt has been made because it would be a strong indicator that the total path of the call had changed, which would only occur if the inherent nature of the call changed (i.e., became a three-way call).

### PRIORITY CLAIM

This application claims priority to previously filed U.S. Provisional Application entitled “COMPARATIVE TONE RETURN TIME THREE-WAY CALL DETECT” assigned Ser. No. 60/617,944, filed on Oct. 12, 2004, which is incorporated herein by reference for all purposes.

### BACKGROUND OF THE INVENTION

The present subject matter relates generally to a method and apparatus for detecting possible three-way call attempts. More particularly, the present subject matter relates to a method and apparatus for measuring the return time of a transmitted tone to determine whether a three-way call attempt is being made.

The present subject matter is directed in one aspect, although not exclusively, toward the penal (i.e., corrections) environment. Law enforcement entities regularly provide prisoners or detainees access to telephones, at least on a limited basis. Many times these law enforcement entities find it desirable, even necessary, to record, or at least monitor, some or all of such telephone conversations. These efforts often require the use of highly specialized telecommunications equipment and facilities to meet the various needs of governmental officials and others in addressing the desire to monitor and/or record telephone conversations under varying circumstances. As a non-limiting example, the remainder of the present disclosure will refer to the monitoring of telephone conversations with an emphasis on detecting possible three-way call attempts during telephone conversations within the above noted particular environment. It is to be strictly understood, however, that the present technology may be applied to and/or used within other areas where monitoring for three-way call attempts may be of interest. For example, it may be desirable to monitor a privately owned pay phone for three-way call attempts where such calling is not permitted. As such, it should be understood that the present technology has applicability to any situation where there is a need or desire to monitor a telephone conversation during which an attempt may be made to effect an impermissible three-way connection.

It has been common practice for many years in the penal (corrections) environment to record and/or monitor inmates' conversations. Such recording and monitoring takes place in the very controlled atmosphere of permitted inmate communications with individuals outside or inside facilities housing such prisoners or inmates. Normally prisoners are limited to a small number of individuals that they are permitted to call. These may include family members, their lawyers, and friends and may specifically exclude others, for example judges, jury members, witnesses, and other like individuals to whom calls from a particular inmate may be of a harassing or other problematic nature. There may be time of day, length of call, three-way call or other restrictions on calls, all of which must be controlled by way of various instrumentalities that may include computer controlled equipment at the facility and/or at remote locations in addition to human monitoring and/or control. In almost all instances, such telephone calls are required to be recorded; yet even in those instances, there are conditions that may impact on the desire, ability, or legal right to record such conversations. For example, it is inappropriate to record or monitor conversations between an inmate and his/her attorney, and thus, measures must be taken to insure that, where calls are made from an inmate to his/her attorney, no recording is made or monitoring is allowed.

One particularly troubling possibility is the attempt by inmates to circumvent call restrictions to unauthorized individuals through the activity of accomplices either inside or outside the corrections facility. In particular, the practice of attempting three-way calling to contact unauthorized individuals can be difficult to control.

The particular needs described above have been addressed in the prior art, which, in major part, has provided responses to accommodate the majority of the needs addressed. Examples of such include LazerPhone™ and LazerVoice®, products provided by the assignee of the present subject matter. LazerPhone™ is a centralized, PC-based, integrated telephone system with features that provide control of inmate telecommunications activities. The system provides call blocking and monitoring, account control including personal identification number (PIN) setup and control, report generation including automated trouble reports, call activity reports and other administrative reports as well as numerous other features.

LazerVoice® is an optional feature of LazerPhone™ and provides a recording function for the LazerPhone™ system. LazerVoice® is a modular system that provides the ability to record selected telephone conversations, permit monitoring by appropriate authorities of selected conversations, and store for later retrieval recorded conversations as well as other functions and operations involving the recording of telephone conversations. Additional information regarding these products may be found at the World Wide Web site, www.gtl.us/, of the corporate owner of the present application interests.

Various techniques have been proposed to detect attempted three-way calling which generally attempt to detect tell-tell sounds occurring during a telephone conversation. One example is found in U.S. Pat. No. 5,319,702 (Kitchin et al.), which disclosed listening for or monitoring for a hook flash type signal. The particular disclosure there was to a device that incorporated a low pass filter and an energy level detector to evaluate the frequency composition of signals in an effort to detect the “click” sometimes associated with the act of generating a hook flash signal which may be used to initiate a three-way call. Another technique was disclosed in U.S. Pat. No. 5,926,533 (Gainsboro), which monitored an ongoing telephone conversation for the occurrence of various tones which normally should not be heard during a conversation and could be associated with a three-way call attempt. These tones, generally referred to as “call progress” tones, included such tones as a ring signal, a busy signal, and special information tones (SIT) as well as dual tone multi-frequency (DTMF) tones or so-called Touch Tones, or other tones that occur when calls are placed, but which should not normally be heard during a call in progress.

Neither of these techniques have proven to be fully effective, however, as both had their own problems. The “click” sound which may have been quite noticeable through the technology of previous telephone systems and switches is now very seldom heard or detectable as the more modern switches filter out the sound or don't pass the required frequency range well enough for dependable detection of the “click.” Moreover, the same hook flash, even if reliably detectable, is used in the telephone industry for other, strictly legitimate activity, which, if occurring, should preferably not be used to disconnect a call being monitored for three-way call attempts. One example of such a legitimate activity would be to use the hook flash signal to place one call on “hold” in order to answer another incoming call. Flagging a “three-way call detect” in such instance would be a “false positive.” The resulting termination during a “false positive” may satisfy institutional performance criteria but in the long run may engender significant (and undesirable) inmate dissatisfaction. As with the “click” detection problem, the approach disclosed by Gainsboro also had problems in that it was potentially circumvented. That is, a called party could make certain that any attempted three-way calls were actually completed and/or had the third party connected before he generated a second hook flash signal to connect the parties thus avoiding any chance of a detectable call progress or other tone appearing on the line.

Thus, while it is considered well known that three-way call detection during inmate telephone conversations is advantageous to governmental agencies and others in that such detection combats both harassment type calls and general continuing criminal activity, effective monitoring for and detection of such calls remains a challenge despite major efforts in the industry.

While various aspects and alternative features are known in the field of telecommunications and telephone conversation monitoring, no one design has emerged that generally integrates all of the ideal features and performance characteristics as discussed herein.

### SUMMARY OF THE INVENTION

The present subject matter recognizes and addresses several of the foregoing shortcomings, and others concerning certain aspects of monitoring telephone conversations within a corrections environment.

Thus, broadly speaking, aspects of some embodiments of the presently disclosed technology concern the provision of improved apparatus and corresponding methodology to provide for the monitoring of telephone conversation. More particularly, certain aspects of some embodiments of the disclosed technology relate to an improved apparatus and corresponding methodology, the provision and practice of which will help insure that monitored telephone conversations will have the highest possible opportunity of being flagged or terminated upon three-way call attempts being made.

Another aspect of the present subject matter is that the nature of the “monitoring” performed does not rely on interpreting spoken language. This means that dialects and foreign languages present no issue, and that call which may not be monitored as to content (such as to an inmate's attorney) may none the less be “monitored” or “screened” with practice of the present subject matter, for disallowing three-way call activity.

Another aspect of certain embodiments of the present subject matter is to provide an improved apparatus and corresponding methodology that will reliably flag or terminate a three-way call attempt without affecting calls that may include similar characteristics of a three-way call attempt. In this fashion, so-called “false positives” are minimized.

A further aspect of certain embodiments of the present subject matter is to provide an improved apparatus and corresponding methodology for detecting three-way call attempts that is effective without regard to the type of telephone system being used, for example, regardless of whether associated voice communications paths are analog-based, digital-based, or a mixture thereof.

Additional aspects and advantages of the present subject matter are set forth in, or will be apparent to those of ordinary skill in the art from, the detailed description herein. Also, it should be further appreciated by those of ordinary skill in the art that modifications and variations to the specifically illustrated, referenced, and discussed features and steps hereof may be practiced in various embodiments and uses of this subject matter without departing from the spirit and scope thereof, by virtue of present reference thereto. Such variations may include, but are not limited to, substitution of equivalent means and features, materials, or steps for those shown, referenced, or discussed, and the functional, operational, or positional reversal of various parts, features, steps, or the like.

Still further, it is to be understood that different embodiments, as well as different presently preferred embodiments, of this invention may include various combinations or configurations of presently disclosed features, steps, or elements, or their equivalents (including combinations of features or steps or configurations thereof not expressly shown in the figures or stated in the detailed description).

A first exemplary embodiment of the present subject matter relates to an improved apparatus and corresponding methodology for detecting three-way call attempts.

Another exemplary embodiment of the present subject matter relates to an improved apparatus and corresponding methodology for monitoring telephone voice transmission paths.

A more particular exemplary embodiment of the present technology relates to an improved apparatus and corresponding methodology for monitoring a telephone voice transmission path and detecting certain changes in the transmission path during the course of a telephone conversation.

Yet another present exemplary embodiment relates to a call monitoring system for detecting possible three-way call attempts during telephone conversations. Such exemplary system preferably includes at least one call origination instrument; at least one call destination instrument; a voice communications path for coupling of the at least one call origination instrument to the said at least one call destination instrument for carrying on such voice communications path a telephone conversation between users of the at least one call origination instrument and the at least one call destination instrument; and three-way call detection means, operatively associated with such voice communications path, for determining a possible three-way call attempt during a telephone conversation carried on such path, by monitoring changes in such voice communications path during a telephone conversation carried thereon, such changes being characterized by changes in the length of time required for a tone burst to travel such voice communications path.

In such exemplary system, such three-way call detection means may preferably include a tone generator having an output coupled to such voice communications path; a tone detector having an input coupled to the such voice communications path and an output providing a signal upon detection of one or more predetermined tones on such voice communications path; and controller means, operatively associated with such tone generator so as to controllably produce a reference burst of at least one of the one or more predetermined tones therefrom, and operatively associated with such tone detector so as to respond to a signal from such tone detector, for determining the length of time between a produced reference burst from the tone generator and the signal from said tone detector.

Such exemplary controller means may be further operative for storing such length of time as a reference time; instructing such tone generator to produce a subsequent burst of such one or more predetermined tones; responding to a corresponding subsequent signal from such tone detector; determining a subsequent length of time between such produced subsequent burst from such tone generator and a corresponding subsequent signal from such tone detector; and comparing such subsequent length of time with such reference time; and for producing a three-way call attempt indication if the difference between such reference time and such subsequent length of time exceeds a predetermined time.

In alternative embodiments of the foregoing, such controller means may be operatively associated with such tone generator so as to controllably produce a burst of at least one of the one or more predetermined tones therefrom, and operatively associated with such tone detector so as to respond to a signal from such tone detector, for determining the length of time between a produced burst from such tone generator and such signal from the tone detector, for comparing said such determined length of time with a stored reference time, and for producing a three-way call attempt indication if the difference between such stored reference time and such determined length of time exceeds a predetermined time.

Still further exemplary embodiments of the present subject matter may relate to a three-way call detector for use with a voice communications path comprising one or more of an analog-based communications path, a digital-based communications path, a public service telephone network (PSTN), a direct connection, a dedicated communications line, a PBX system, a voice over Internet protocol (VoIP) system, a wireless system, and an optical system. Such a present exemplary three-way call detector may comprise a tone generator; a tone detector; a coupler for coupling tones from such tone generator to a voice communications path associated with such coupler and for coupling tones from such associated voice communications path to such tone detector; and a controller.

In such exemplary present arrangement, such controller may be advantageously configured in accordance with present subject matter to cause such tone generator to respectively produce a first tone and a second tone, to respond to a first signal from such tone detector produced whenever such tone detector detects such first tone; to respond to a second signal from such tone detector produced whenever such tone detector detects such second tone; to calculate the difference between the length of time between such first tone and such first signal and the length of time between such second tone and such second signal; and to produce an alarm signal if such difference exceeds a predetermined amount.

Still further, preferably in such exemplary three-way call detector, the controller is preferably further configured so as to cause such tone generator to produce such first tone during an initial portion of a call conducted on the associated voice communications path. Still further, such controller may be configured so as to cause such tone generator to produce such second tone at either of predetermined intervals or at random intervals during a call conducted on the associated voice communications path.

Still further, a present exemplary methodology for detecting a three-way call attempt on a voice communications path, may comprise the steps of: applying a first tone burst to a voice communications path during an initial portion of a call conducted on such voice communications path; determining the length of time required for the first tone burst to traverse the voice communications path; applying a second tone burst to the voice communications path; determining the length of time required for the second tone burst to traverse the voice communications path; determining the difference between the length of time required for the first tone burst to traverse the voice communications path and the length of time required for the second tone burst to traverse the voice communications path; and determining the occurrence of a possible three-way call attempt if such difference exceeds a predetermined length of time.

In the foregoing exemplary present methodology, the steps of applying may respectively comprise applying either a single frequency tone burst r a dual frequency tone burst to the voice communications path.

Still further in such exemplary present methodology, the steps of applying may respectively comprise applying a tone burst having a frequency about in the range of 300 Hz to 3000 Hz.

In yet another exemplary present methodology, a method for detecting a three-way call attempt on a voice communications path between a calling telephone and a called telephone, by using comparative return times for tones, may comprise the exemplary steps of: transmitting an audio frequency range tone over the loop of a voice communications path established from a calling telephone to a called telephone; measuring the tone return time; using the measured tone return time as a base measurement comparison time for additional tone return measurements during the course of a phone conversation between the calling telephone and the called telephone; and determining the occurrence of a three-way call attempt if a tone return time for a subsequent measurement thereof deviates significantly from the base measurement tone return time.

Additional embodiments of the subject technology, not necessarily expressed in this summarized section, may include and incorporate various combinations of aspects of features, parts, or steps referenced in the summarized objectives above, and/or features, parts, or steps as otherwise discussed in this application.

Those of ordinary skill in the art will better appreciate the features and aspects of such embodiments, and others, upon review of the remainder of the specification.

### BRIEF DESCRIPTION OF THE DRAWINGS

A full and enabling description of the present subject matter, including the best mode thereof, directed to one of ordinary skill in the art, is set forth in the specification, which makes reference to the appended figures, in which:

FIG. 1 is a generally representational block diagram illustrating an overview of the present subject matter; and

FIG. 2 representatively illustrates elements of the three-way call detector of the present technology.

Repeat use of reference characters throughout the present specification and appended drawings is intended to represent same or analogous features, steps or elements of the subject technology.

### DETAILED DESCRIPTION OF THE DRAWINGS

As referenced in the Summary of the Invention section, supra, the present subject matter is directed towards an improved apparatus and corresponding methodology for monitoring telephone conversations, more specifically, monitoring for attempted three-way calls occurring during telephone conversations.

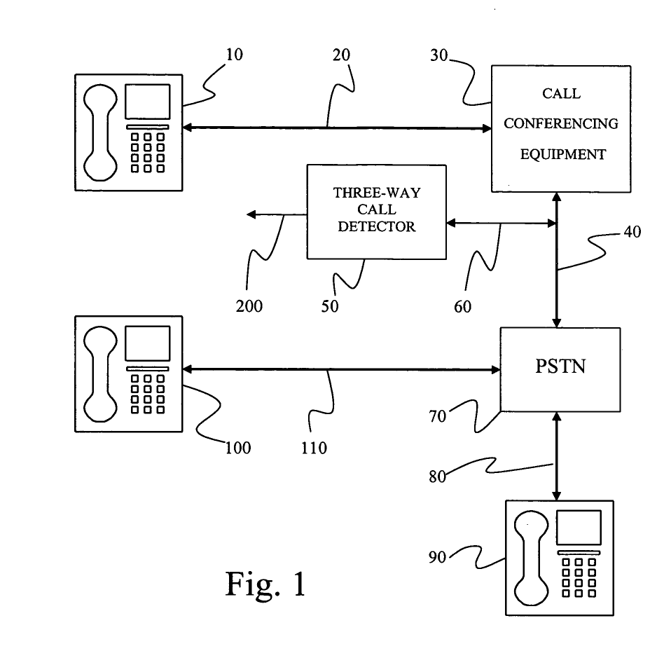

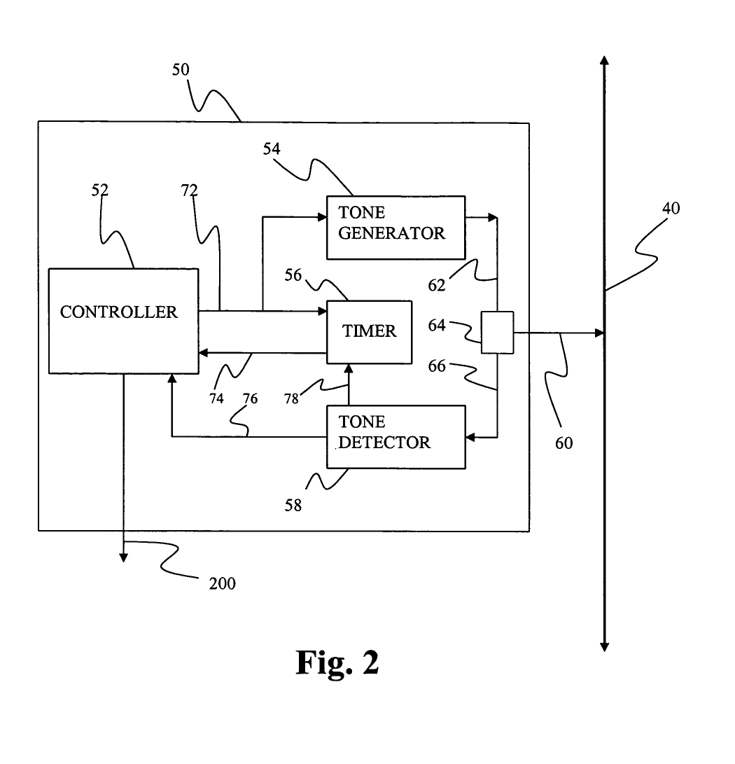

Reference will now be made to the presently disclosed technology, specifically with reference to FIGS. 1 and 2. It will be observed from FIG. 1 that the present technology is directed to apparatus and a methodology for monitoring telephone conversations and detecting three-way call attempts through the use of a three-way call detector (also referenced herein as three-way call detection means) 50 whose specific operation will be described more fully later. As diagrammatically illustrated in FIG. 1, the present technology is employed in combination with telephone equipment generally including at least a call origination telephone instrument 10, a destination telephone instrument 90 and a third party telephone instrument 100. These telephone instruments may be coupled together for voice communications by way of call conferencing equipment 30, the Public Switched Telephone Network (PSTN) 70 and various interconnecting lines 20, 40, 80, and 110.

It should be clearly understood that call origination telephone instrument 10, while illustratively shown as a single instrument, is meant to represent any number of instruments located singly or in groups at one or more facilities at one or more physical locations. In an exemplary embodiment of the present technology, origination telephone instrument 10 may constitute a telephone instrument placed for use by inmates within a corrections environment. However, it should be strictly understood that this is exemplary only as the present technology may also be used in combination with a variety of telephonic configurations limited only by a desire or need to monitor conversations for three-way call attempts on the part of conversation participants.

In line with the foregoing, it should also be clearly understood that call conferencing equipment 30 and the representatively illustrated line 20 coupling the call conferencing equipment 30 to call origination telephone instrument 10 is meant to represent a variety of different connecting configurations. The representatively illustrated direct connection line 20 may, therefore, constitute any number of connecting mechanisms usable to connect call origination telephone instrument 10 to call conferencing equipment 30. Non-limiting examples may have connecting line 20 representing the Public Switched Telephone Network, a direct or dedicated line connection, a so-called PBX type connection, a voice over internet protocol (VoIP) connection, a wireless connection, an optical connection, or any other type of connection which couples call origination telephone instrument 10 to call conferencing equipment 30.

Call conferencing equipment 30 is also representatively illustrated and is, therefore intended to illustrate a number of different configurations. Non-limiting examples include equipment co-located with call origination telephone instrument 10, equipment located at a central facility in the vicinity of the call origination telephone instrument 10, equipment located at a telephone company central office, equipment located at a remote facility, or equipment located at any other location or combined with other telephonic equipment. Such “equipment” may in fact, involve various mixtures of hardware and/or software or other forms of implementation. For purposes of the present technology and the disclosure relevant to the present subject matter, it is important only that the call conferencing equipment 30 be able to connect a call from call origination telephone instrument 10 to a call destination telephone instrument 90 by way of trunk lines 40.

Also illustrated in FIG. 1 are call destination telephone instrument 90, third party telephone instrument 100 and coupling lines 80 and 110. As with coupling line 20 discussed supra, coupling lines 80 and 110 are representatively illustrated as direct connections between respective telephone instruments and the Public Switched Telephone Network (PSTN) 70. However, these lines 80 and 110 may also consist of any other type connection as described supra with respect to line 20.

The general operation of the arrangement illustrated in FIG. 1 is as follows. An individual wishing to make a telephone call begins by picking up the handset associated with call origination telephone instrument 10. Depending on the type of telephone service provided, the caller may hear a dial tone or, in the case of the exemplary corrections environment, may be presented with a series of prompts requiring him/her to enter such as a personal identification number (PIN) or other identifying data as well as a call destination number and other such information as may be required by the telephone service. Such features and operational processes are not, however, a limitation to the present technology. The relevant portion of the particular telephone systems operation is that the system operators have an interest in detecting possible three-way call attempts. After the caller presents any required data or information (and assuming the data or information is accepted by the telephone system operators or automated equipment associated with the telephone service), a voice connection or “conference” is established with the call destination telephone instrument 90 and the three-way call detector 50 is activated in a manner that will be more fully described later. As the conversation proceeds, there may come a time when one of the parties participating in the conversation attempts to initiate a three-way call to a third party telephone instrument 100. In the exemplary situation of a corrections environment telephone system, the party attempting to make a three-way call more than likely would be an individual at the original destination telephone instrument. However, such may not be the case in other environments or under certain circumstances and thus the present technology is not so limited.

With reference now to FIG. 2, a more specific discussion of the operational aspects of the three-way call detector 50 will be undertaken. Three-way call detector 50 is, in one embodiment of the present technology, embodied as multiple dedicated elements and will be further described as such but only out of convenience as the to be described elements may just as easily be embodied as software running on a general purpose or dedicated computer or embodied as various hardware/software mixtures. Thus, any reference contained herein to apparatus for carrying out the various functions described should be broadly construed to cover hardware, software, firmware or any other mechanism, technique or methodology or any combination thereof which, in the aggregate is capable of effecting the disclosed functionality.

With specific reference now to FIG. 2, there is representatively illustrated an arrangement 50 designed to detect three-way call attempts. Specifically, the arrangement includes a controller (also referenced herein as controller means) 52, a tone generator 54, a timer 56, a tone detector 58, and a coupler 64. In brief, the overall operation of the present technology may be viewed as operating on the principle of transmitting a tone burst over an established telephone conference, timing the elapsed time for the tone to travel over the communications loop established between the caller and called party and storing the measured elapsed time as a base reference time for future measurements. During the course of the ongoing conversation, one or more additional tones are generated by the tone generator 54 and timed by timer 56. The resulting subsequently measured elapsed time is then compared to the first measured (i.e. base) reference time. If there is sufficient deviance between any subsequently measured elapsed time and the base reference time, the call will be determined to be a three-way call attempt. Differences in elapsed time come about due to the fact that another telephone loop or an extension of the originally established telephone loop has been put into place by virtue of the difference in physical distances traveled by the tone burst. Stated another way, this operation involves “pinging” a target to ascertain the distance from a “ping” source to a target based on the time required to hear a “return” signal from the target. If the target moves, the return time changes. In the present environment, if the “target,” in this case the called party, moves or changes by adding on or becoming a third party, the “return” signal will require a different transit time from that of the originally called party “target” and, thus may be detected by comparing the current return time with the base reference return time.

Returning now more specifically to FIG. 2, tone generator 54 is controlled by controller 52 by way of control lines 72 and is designed to generate at least one oscillatory tone signal within an audio frequency range normally associated with telephonic communications. Generally such telephonic communications are limited by equipment and other design consideration to the range from about 300 Hz to about 3,000 Hz. However such specific range is exemplary only of the present technology, which is not so limited but rather is limited only by frequency ranges actually capable of being passed over and through the telephonic equipment employed in conjunction with the present technology. Moreover, the oscillatory tone generated by tone generator 54 may comprise single tones individually generated on individual single frequencies or individually generated on a number of different frequencies at separate or different times or may constitute two or more tone frequencies generated concurrently all under control of controller 52.

Generally speaking, a telephone conversation is conducted over two paths, an “ear” path and a “mouth” path. A calling part is connected to or conferenced with a called party by connecting the calling party's “mouth” path to the called party's “ear” path and vice-versa for the called party. In the corrections environment, the calling party's (i.e. the inmates) “ear” path may optionally be disable during the call set up portion of the call to prevent the inmate caller from hearing any so-called call progress tones. In an exemplary embodiment of the present subject matter, controller 52 will instruct, direct, or enable tone generator 54 to generate a single tone at a predetermined time and for a predetermined time period. The generated tone is coupled to the calling party's “mouth” path by way of coupling device 64, travels over the conferenced call to the called party's “ear” path and then returns over the called party's “mouth” path. Coupling device 64 may consist of a so-called telephone hybrid circuit, a capacitive coupling device or any other device capable of coupling a tone to the calling party's “mouth” path over trunk line 40. In an exemplary embodiment of the present technology, the tone generator will be activated a first time as the voice connection between the caller and called party is established and the tone will be generated only for a relatively short time and then terminated. In effect, the controller will cause the tone generator 54 to “ping” the called telephone. At the time of the tone generation, the “ear” path to the calling party may be disable such that the caller inmate may hear a “skip” or slight break in the connection, but nothing else.

At the same time controller 52 is communicating with tone generator 54 to generate a tone, timer 56 starts timing a time period from the same moment tone generator 54 starts generating the tone. After a predetermined tone generation time period, controller 52 instructs, directs or enables tone detector 58 to listen for a return tone over the caller's “ear” path via lines 40 and 60, coupler 64 and tone detector input line 66. Upon detection of a return tone, tone detector 58 notifies the controller 52 by way of a signal on line 76 that a return tone has been detected and, simultaneously, timer 56 is instructed to stop timing by way of a signal on line 78. The controller then obtains the elapsed time from timer 56 by way of signal line 74 and stores the time value so that it may be used as a base reference time for additional tests later during the same conversation.

During the course of the telephone conversation, the above-described tone generation, timing and tone detection sequence may be repeated and the resultant elapsed time compared against the stored base reference time. If the resultant elapsed time deviates sufficiently from the stored base reference time, a determination is made that a three-way call attempt has been made and an indication of that attempt is signaled over line 200. As an example only, the time difference between the stored base reference time and a subsequently measure time where a three-way call has been made may be measured in terms of milliseconds. This measurement difference is in no way limiting, however, as it should be quite evident to those of ordinary skill in the art that the time difference is based on the additional distance traveled by the tone as it traverses the “mouth” and “ear” paths of any conferenced calls. Repeated measurement sequences may be conducted upon occurrence of specific events or activities that may tend to indicate an attempt to initiate a three-way call or may be conducted on a timed or random basis at times throughout the conversation. The signal issued over line 200 indicating the detection of a three-way call attempt may be used by other apparatus to disconnect the call, provide an alarm signal to authorities, generate a voice warning to the call participants, provide an indication or flag within a call record of the attempt or trigger any other desired activity as may be selected by the system users/operators.

Thus there has been described an apparatus and methodology for detecting three-way call attempts that, unlike previous technology is not affected by problematic and difficult detections of “clicks” or other more or less extraneous noises on the line which may or may not actually be passed by the telephone system. Nor is the present technology susceptible of being circumvented by avoiding placement of so-called call progress tones or other tones that may be detected as inappropriate tones to be heard on a call in progress. Moreover, the present technology may be used to monitor or screen even those calls which otherwise may not be monitored, such as calls to an inmate's attorney, for three-way call detection.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A call monitoring system for detecting possible three-way call attempts during telephone conversations, said system comprising:
at least one call origination instrument;
at least one call destination instrument;
a voice communications path for coupling of said at least one call origination instrument to said at least one call destination instrument for carrying on said voice communications path a telephone conversation between users of said at least one call origination instrument and said at least one call destination instrument; and
three-way call detection means, operatively associated with said voice communications path, for determining a possible three-way call attempt during a telephone conversation carried on said path, by monitoring changes in said voice communications path during a telephone conversation carried thereon, such changes being characterized by changes in the length of time required for a tone burst to travel said voice communications path.

2. A call monitoring system as in claim 1, wherein said three-way call detection means includes:
a tone generator having an output coupled to said voice communications path;
a tone detector having an input coupled to said voice communications path and an output providing a signal upon detection of one or more predetermined tones on said voice communications path; and
controller means, operatively associated with said tone generator so as to controllably produce a reference burst of at least one of said one or more predetermined tones therefrom, and operatively associated with said tone detector so as to respond to a signal from said tone detector, for determining the length of time between a produced reference burst from said tone generator and said signal from said tone detector.

3. A call monitoring system as in claim 2, wherein said controller means is further operative for storing said length of time as a reference time; instructing said tone generator to produce a subsequent burst of said one or more predetermined tones; responding to a corresponding subsequent signal from said tone detector; determining a subsequent length of time between said produced subsequent burst from said tone generator and a corresponding subsequent signal from said tone detector; and comparing said subsequent length of time with said reference time.

4. A call monitoring system as in claim 3, wherein said controller means is further operative for producing a three-way call attempt indication if the difference between said reference time and said subsequent length of time exceeds a predetermined time.

5. A call monitoring system as in claim 3, wherein said reference burst of said one or more predetermined tones and said subsequent burst of said one or more predetermined tones each comprises a single burst of a single tone.

6. A call monitoring system as in claim 5, wherein said single tone has a frequency about in the range from 300 Hz to 3000 Hz.

7. A call monitoring system as in claim 3, wherein said reference burst of said one or more predetermined tones and said subsequent burst of said one or more predetermined tones each comprises a single burst of a pair of tones.

8. A call monitoring system as in claim 7, wherein each tone of said pair of tones has a frequency about in the range from 300 Hz to 3000 Hz.

9. A call monitoring system as in claim 1, wherein said voice communications path comprises one or more of an analog-based communications path, a digital-based communications path, a public service telephone network (PSTN), a direct connection, a dedicated communications line, a PBX system, a voice over Internet protocol (VoIP) system, a wireless system, and an optical system.

10. A call monitoring system as in claim 1, wherein said three-way call detection means includes:
a tone generator having an output coupled to said voice communications path;
a tone detector having an input coupled to said voice communications path and an output providing a signal upon detection of one or more predetermined tones on said voice communications path; and
controller means, operatively associated with said tone generator so as to controllably produce a burst of at least one of said one or more predetermined tones therefrom, and operatively associated with said tone detector so as to respond to a signal from said tone detector, for determining the length of time between a produced burst from said tone generator and said signal from said tone detector, for comparing said said determined length of time with a stored reference time, and for producing a three-way call attempt indication if the difference between said stored reference time and said determined length of time exceeds a predetermined time.

11. A three-way call detector for use with a voice communications path comprising one or more of an analog-based communications path, a digital-based communications path, a public service telephone network (PSTN), a direct connection, a dedicated communications line, a PBX system, a voice over Internet protocol (VoIP) system, a wireless system, and an optical system, said three-way call detector comprising:
a tone generator;
a tone detector;
a coupler for coupling tones from said tone generator to a voice communications path associated with said coupler and for coupling tones from such associated voice communications path to said tone detector; and
a controller configured to:
cause said tone generator to respectively produce a first tone and a second tone,
respond to a first signal from said tone detector produced whenever said tone detector detects said first tone;
respond to a second signal from said tone detector produced whenever said tone detector detects said second tone;
calculate the difference between the length of time between said first tone and said first signal and the length of time between said second tone and said second signal; and
produce an alarm signal if said difference exceeds a predetermined amount.

12. A three-way call detector as in claim 11, wherein said controller is further configured so as to cause said tone generator to produce said first tone during an initial portion of a call conducted on the associated voice communications path.

13. A three-way call detector as in claim 12, wherein said controller is further configured so as to cause said tone generator to produce said second tone at predetermined intervals during a call conducted on the associated voice communications path.

14. A three-way call detector as in claim 12, wherein said controller is further configured so as to cause said tone generator to produce said second tone at random intervals during a call conducted on the associated voice communications path.

15. A three-way call detector as in claim 11, wherein said alarm signal comprises a voice announcement to participants on the call conducted on the associated voice communications path.

16. A three-way call detector as in claim 11, wherein said alarm signal terminates the call conducted on the associated voice communications path.

17. A method for detecting a three-way call attempt on a voice communications path, comprising the steps of:
applying a first tone burst to a voice communications path during an initial portion of a call conducted on such voice communications path;
determining the length of time required for the first tone burst to traverse the voice communications path;
applying a second tone burst to the voice communications path;
determining the length of time required for the second tone burst to traverse the voice communications path;
determining the difference between the length of time required for the first tone burst to traverse the voice communications path and the length of time required for the second tone burst to traverse the voice communications path; and
determining the occurrence of a possible three-way call attempt if such difference exceeds a predetermined length of time.

18. A method for detecting a three-way call attempt on a voice communications path as in claim 17, wherein the steps of applying respectively comprise applying a single frequency tone burst to the voice communications path.

19. A method for detecting a three-way call attempt on a voice communications path as in claim 17, wherein the steps of applying respectively comprise applying a dual frequency tone burst to the voice communications path.

20. A method for detecting a three-way call attempt on a voice communications path as in claim 17, wherein the steps of applying respectively comprise applying a tone burst having a frequency about in the range of 300 Hz to 3000 Hz.

21. A method for detecting a three-way call attempt on a voice communications path as in claim 17, wherein the step of applying a second tone burst comprises applying such second tone burst to the voice communications path a predetermined time after the step of applying a first tone burst.

22. A method for detecting a three-way call attempt on a voice communications path as in claim 17, wherein the step of applying a second tone burst comprises applying such second tone burst to the voice communications path a random time after the step of applying a first tone burst.

23. A method for detecting a three-way call attempt on a voice communications path between a calling telephone and a called telephone, by using comparative return times for tones, comprising the steps of:
transmitting an audio frequency range tone over the loop of a voice communications path established from a calling telephone to a called telephone;
measuring the tone return time;
using the measured tone return time as a base measurement comparison time for additional tone return measurements during the course of a phone conversation between the calling telephone and the called telephone; and
determining the occurrence of a three-way call attempt if a tone return time for a subsequent measurement thereof deviates significantly from the base measurement tone return time.

24. A method for detecting a three-way call attempt as in claim 23, wherein said audio frequency range tones comprise single frequency tone bursts to the voice communications path.

25. A method for detecting a three-way call attempt as in claim 23, wherein said audio frequency range tones comprise dual frequency tone bursts to the voice communications path.

26. A method for detecting a three-way call attempt as in claim 23, wherein said audio frequency range tones comprise tone bursts having frequencies about in the range of 300 Hz to 3000 Hz.

27. A method for detecting a three-way call attempt as in claim 23, wherein the additional tone return measurements are conducted at a predetermined time or times after the base measurement tone return time is measured.

28. A method for detecting a three-way call attempt as in claim 23, wherein the additional tone return measurements are conducted at a random time or times after the base measurement tone return time is measured.
